(19) United States
(12) Patent Application Publication
(10) Pub. No.: US 2019/0057548 A1
(43) Pub. Date: Feb. 21, 2019

(54) SELF-LEARNING AUGMENTED REALITY FOR INDUSTRIAL OPERATIONS

(71) Applicant: General Electric Company, Schenectady, NY (US)

(72) Inventors: Baljit SINGH, Niskayuna, NY (US); Zhiguang WANG, San Ramon, CA (US); Jianbo YANG, San Ramon, CA (US); Sundar MURUGAPPAN, San Ramon, CA (US); Jason NICHOLS, Niskayuna, NY (US)

(21) Appl. No.: 15/678,654

(22) Filed: Aug. 16, 2017

(51) Int. Cl. G06T 19/00; G06K 9/00; G06K 9/62

(52) U.S. Cl. CPC G06T 19/006; G06K 9/00671; G06T 2219/004; G06K 9/6263; G06K 2209/19; G06K 9/6256

(57) ABSTRACT

The example embodiments are directed to a system for self-learning augmented reality for use with industrial operations (e.g., manufacturing, assembly, repair, cleaning, inspection, etc.) performed by a user. For example, the method may include receiving data captured of the industrial operation being performed, identifying a current state of the manual industrial operation based on the received data, determining a future state of the manual industrial operation that will be performed by the user based on the current state, and generating one or more augmented reality (AR) display components based on the future state of the manual industrial operation, and outputting the one or more AR display components to an AR device of the user for display based on a scene of the manual industrial operation. The augmented reality display components can identify a future path of the manual industrial operation for the user.

### BACKGROUND

Machine and equipment assets, generally, are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles such as trains and aircraft, and the like. As another example, assets may include devices that aid in diagnosing patients such as imaging devices (e.g., X-ray or MRI systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies have created opportunities for creating novel industrial and healthcare based assets with improved sensing technology and which are capable of transmitting data that can then be distributed throughout a network. As a consequence, there are new opportunities to enhance the business value of assets and the interaction therewith through the use of novel industrial-focused hardware and software.

Augmented reality is a technology that imposes or otherwise adds computer-generated sensory components (e.g., graphics, sound, video, etc.) within a user's field of view of the real world providing an augmented live experience that includes both real components and holographic components. Augmented reality enhances a user's perception of the real world in contrast with virtual reality which replaces the real world with a simulated world. Some challenging factors for augmented reality development include the need for knowledge of multiple disciplines such as object recognition, computer graphics, artificial intelligence and human-computer-interaction. Furthermore, a partial context understanding is typically required for the adaptation of the augmented reality to unexpected conditions and to understand a user's actions and intentions.

Recently, augmented reality has been introduced into industrial settings including interaction with various assets both in production and handling after production. However, because the state of these assets and the operations associated therewith are often changing over time, the business/manufacturing content provided from the augmented reality needs to evolve over time, which has led to a bottleneck in augmented reality content development. Current methods of generating content for AR applications are bespoke and typically require a custom made application for each new use-case. Accordingly, what is needed is a new technology capable of providing augmented reality for multiple use cases and also capable of evolving over time.

### SUMMARY

Embodiments described herein improve upon the prior art by providing a learning system which generates augmented reality content for use in industrial settings and which uses various methods from the fields of computer vision, object-recognition, process encoding and machine learning. The learning described herein is directed to the AR system learning from human action. The learning system can be a continuous learning system capable of adapting to changes to business/manufacturing processes performed by a user over time and capable of automatically adapting and modifying augmented reality content that is being output to the user. In some examples, the example embodiments herein may be incorporated within software that is deployed on a cloud platform for use with an Industrial Internet of Things (IIoT) system.

In an aspect of an example embodiment, a computer-implemented method includes receiving data (e.g., images, spatial data, audio, temperature, etc.) that is captured of a manual industrial operation or process including a plurality of steps and which is being performed by a user, identifying a current state of the manual industrial operation that is being performed by the user based on the received image data, determining a future state of the manual industrial operation that will be performed by the user based on the current state, and generating one or more augmented reality (AR) display components based on the future state of the manual industrial operation, and outputting the one or more AR display components to an AR device of the user for display based on a scene of the manual industrial operation.

In an aspect of another example embodiment, a computing system includes a storage device configured to store image data captured of a manual industrial operation which is being performed by a user, a processor configured to identify a current state of the manual industrial operation that is being performed by the user based on the received image data, determine a future state of the manual industrial operation that will be performed by the user based on the current state, and generate one or more augmented reality (AR) display components based on the future state of the manual industrial operation, and an output configured to output the one or more AR display components to an AR device of the user for display based on a scene of the manual industrial operation.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating an augmented reality system in accordance with an example embodiment.

FIG. 2 is a diagram illustrating an augmented reality process in accordance with an example embodiment.

FIG. 3 is a diagram illustrating a user interaction with an industrial asset that is enhanced based on augmented reality in accordance with an example embodiment.

FIG. 4 is a diagram illustrating a method for generating augmented reality components in accordance with an example embodiment.

FIG. 5 is a diagram illustrating a computing system for generating augmented reality components in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments provide an augmented reality (AR) platform that includes a learning system for human (or robot operated) manual industrial operations or processes such as manufacturing operations, repair operations, assembly, maintenance, inspection, and the like, especially in industrial settings such as manufacturing. The operations may be performed on machine, equipment, products, and the like, at a manufacturing plant or other environment, and may be a process that includes a plurality of stages, steps, phases, etc. The platform allows AR devices (e.g., eyeglasses, lenses, head gear, helmets, sensors, cameras, microphone, etc.) to capture real-time video and audio of the process being performed by the user which can be input to the learning system. The learning system may be coupled to the AR device or connected to the AR device via a network or cable. From the observed data, the learning system may generate and continuously update a process map of the operation being performed by the user that represents a current state of the operation and also can be used to predict a future state of the operation. The process map may be used to generate intuitive and efficient instructions for both novice and expert operators to aid and navigate the operator through the process. These instructions may also be delivered through the same AR device that captures the data. Thus, the AR device serves both as the data capture device for input to the learning system and as the content delivery device for the instructions generated by the learning system.

As described herein, augmented reality devices may be used within the industrial workforce to provide 3D digital content (e.g., holographic content) near physical assets and operations within a field of view of the user. Augmented reality devices are used to enhance the real world by adding or overlaying digital content on a field of view of the real world, whereas virtual reality creates a simulation of the real world. Some examples of AR devices that may be used in the system herein include MICROSOFT HOLOLENS®, Meta Vision, DAQRI® Smart Helmet, and the like. The example embodiments address multiple challenges for AR devices in an industrial setting. One of the challenges is generating content at scale. Because the state of an asset and operations change over time, the business/manufacturing content also needs to evolve over time, which leads to a bottleneck in AR content development. Related methods for generating content for AR applications are bespoke (i.e., require custom made applications) for each new use-case. In contrast, the example embodiments provide a learning system that uses techniques from the fields of computer vision, object-recognition, process encoding and machine learning to create a continuous learning system that can learn changes to business/manufacturing processes over time and automatically updates the AR content for a user operated process.

The example embodiments also expand and improve the scope of data collection in an industrial setting. While assets can stream their states from sensory data collected by sensors attached to or around the asset, the physical operations performed by user operators in a manual industrial operation are rarely captured. Tracking such tasks manually requires an enormous effort and amount of resources, and can be a source of inefficiency if done by the operators themselves. To address this issue, the system herein automates data collection for operator performed actions. Moreover, by capturing variations of the operator performed actions in real-time, the system creates a model of the business/manufacturing process that can be continuously updated/modified as a learning system. Through the learning system, ideal or more efficient operation/process paths can be generated that include details at the level of operator performed actions. This level of detail can be used to improve manual industrial processes in a wide variety of applications. For example, there are at least two types of learning which include people learning from AR, and machines learning from people. In the example embodiments, the AR system is learning from actions and steps that are being taken by users, and not the other way around.

As described herein, the industrial or manufacturing process may include an entity such as a user, a machine, a robot, etc., performing operations with respect to industrial or manufacturing based equipment, machines, devices, etc. In some cases, the machine or robot may be under control of a human operator or it may be automated. The machines and equipment may include healthcare machines, industrial machines, manufacturing machines, chemical processing machines, textile machines, locomotives, aircraft, energy-based machines, oil rigs, and the like. The operations performed by the entity may include product assembly activities (e.g., assembly line, skilled labor, etc.) maintenance activities (e.g., component repair, component replace, component addition, component removal, etc.), inspections, testing, cleaning, or any other activities in which a user interacts with a machine or equipment. The operation may be based on a predetermined plan/schedule and may include multiple steps involving interaction with equipment and machinery.

The augmented reality software may be deployed on a cloud platform computing environment, for example, an Internet of Things (IoT) or an Industrial Internet of Things (IIoT) based platform. While progress with machine and equipment automation has been made over the last several decades, and assets have become ‘smarter,’ the intelligence of any individual asset pales in comparison to intelligence that can be gained when multiple smart devices are connected together, for example, in the cloud. Assets, as described herein, may refer to equipment and machines used in fields such as energy, healthcare, transportation, heavy manufacturing, chemical production, printing and publishing, electronics, textiles, and the like. Aggregating data collected from or about multiple assets can enable users to improve business processes, for example by improving effectiveness of asset maintenance or improving operational performance if appropriate industrial-specific data collection and modeling technology is developed and applied.

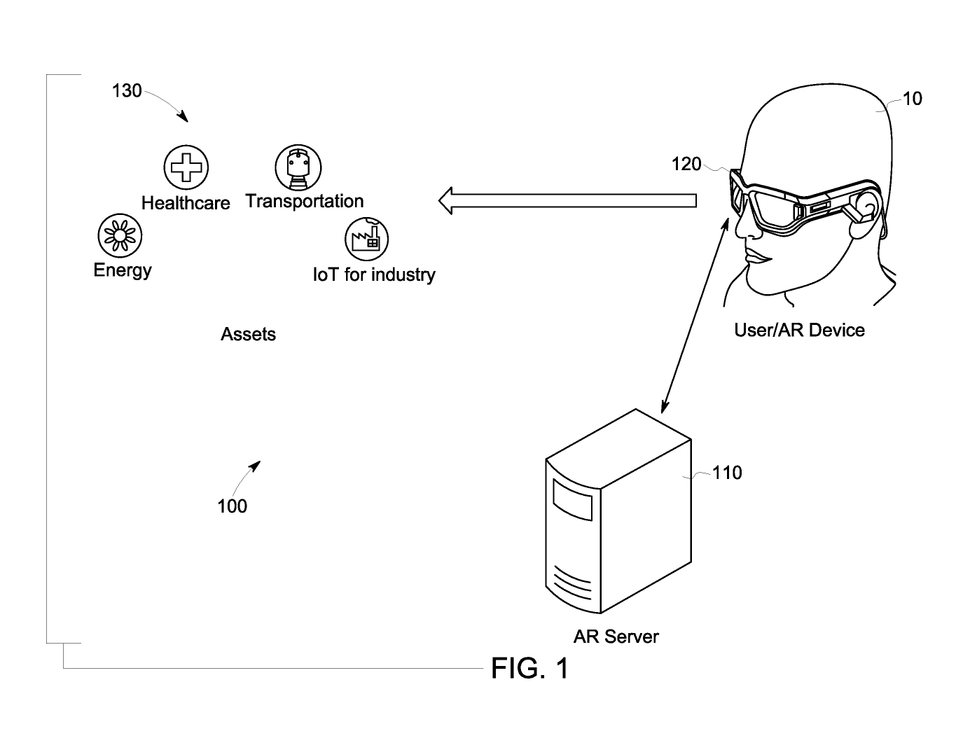

FIG. 1 illustrates an augmented reality system 100 in accordance with an example embodiment. In this example, a user 10 performs operations on one or more types of industrial assets 130 which may include machine and equipment in the fields of transportation, energy, healthcare, manufacturing, and the like. Referring to FIG. 1, the system 100 includes an augmented reality (AR) server 110 in communication with an AR device 120 associated with the user 10. The AR server 110 may be a cloud platform, a server, or another computing device attached to a network. The AR device 120 may be one or more of glasses, a helmet, a screen, a camera, a microphone, and/or the like, which are associated with the user 10. In some examples, the AR device 120 or a plurality of AR devices may be attached to or worn by the user 10. As another example, the AR device 120 may be within a field of view of the user 10 but not attached to the user. The AR server 110 and the AR device 120 may be connected to each other by a network such as the Internet, private network, or the like. As another example, the AR device 120 may be connected to the AR server 110 by a cable or the AR device 120 may incorporate the features of the AR server 110 within the AR device 120.

The AR device 120 may be outfitted with one or more data gathering components (e.g., cameras, sensors, LIDAR, thermal cameras, etc.) which are capable of capturing images, spatial data, audio, temperature, and the like, and which are configured to monitor respective operations or conditions of the user 10 performing operations with respect to an asset 130. Data captured by the AR device 120 can be recorded and/or transmitted to the AR server 120 or other remote computing environment described herein. By bringing the data into the AR system 100, the AR platform described herein which may include software or a combination of hardware and software may analyze a process being performed by the user 10 with respect to the asset 130 and provide augmented reality components that are related to the process. The AR software may be included in the AR server 110, the AR device 120, or a combination thereof. As a non-limiting example, the user 10 may be performing a maintenance process, a repair process, a cleaning process, a production/assembly process, or any other process known in which a user interacts with machines or equipment in an industrial setting. The AR server 120 may analyze the captured data and determine a current state of the process being performed by the user. Furthermore, the AR server 110 can provide augmented reality components to the AR device 120 based on a future state of the process being performed by the user 10. For example, the augmented reality components can indicate a process path or a next part in the operation that is to be replaced/inspected.

Furthermore, the AR software may include a learning system. In this case, the learning system may receive a continuous stream or an intermittent stream of data from the AR device 120, and insights gained through analysis of such data can lead to enhancement of the process being performed by the user 10 based on asset designs, enhanced software algorithms for operating the same or similar assets, better operator efficiency, the current user 10 and/or other users previously performing similar process operations, and the like. In addition, analytics may be used to analyze, evaluate, and further understand issues related to operation of the asset within manufacturing and/or industry. The stream of data may include images, audio, video, spatial data, temperature, and the like, captured by the AR device 120 in real-time and provided to the AR server 110. The images captured by the AR device 120 may include pictures or video of the user performing the process with respect to the machine or equipment.

According to various embodiments, the AR server 110 can analyze the images and/or audio coming in and determine a current state of the process being performed by the user 10 based on the analyzed images/audio with respect to a one or more models maintained by the AR server 110. For example, the AR server 110 may maintain a process map including images of the process performed previously by the user 10 or other users as well as descriptions, images, and audio of the individual steps/phases of the process being performed by the user 10. The AR server 110 may determine augmented reality components to output based on a state of the process. For example, the AR server 110 may determine augmented reality components to output based on a previous state, a current state and/or a future state of the process. According to various embodiments, the augmented reality components may be output to the AR device 120. Accordingly, the same device may capture process data being performed by the user and output suggestions or other enhancements, simultaneously.

The AR software described herein may be deployed on the AR server 110 or another server such as a cloud platform, and may learn from process performed by the user 10. For example, the AR server 110 may store historical information provided in connection with a process being performed by a user for a type of asset. As will be appreciated, an asset (e.g., type of machine or equipment) may have dozens or even hundreds of user operations performed therewith for many reasons such as assembly, maintenance, inspection, failure, cleaning, and the like. For example, a healthcare machine or a manufacturing machine may have hundreds of parts and/or software that need repair or replacement. Accordingly, there may be hundreds of different processes associated with a machine or equipment. The AR software may identify a current process being performed from among the many different process automatically based on the data captured by the AR device 120. Furthermore, the AR software may automatically provide enhancements to the process being performed by the user 10 based on a process map controlled and updated by the learning system.

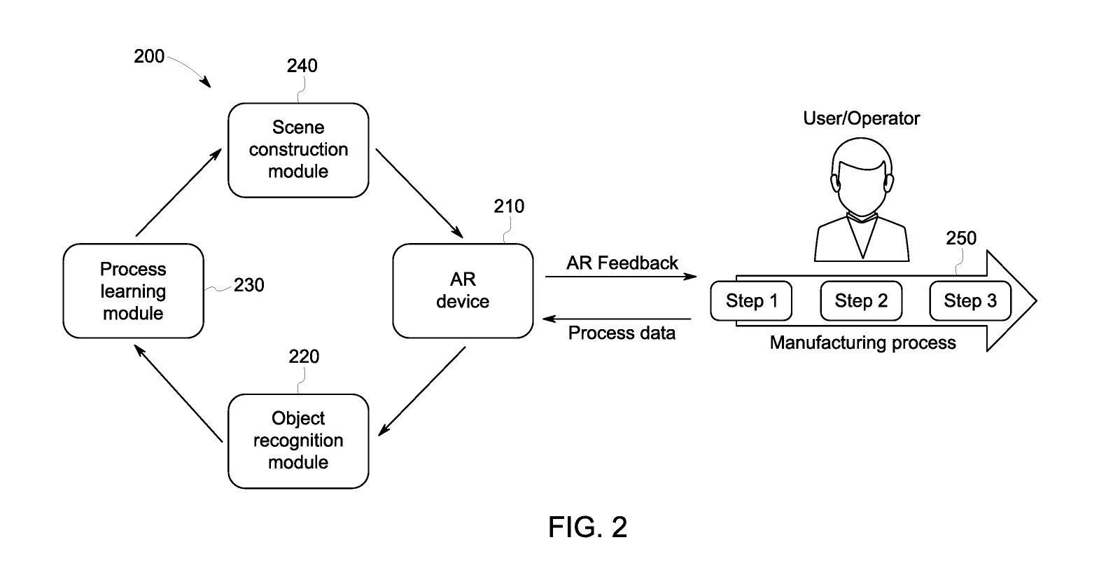

FIG. 2 illustrates an augmented reality process 200 in accordance with an example embodiment. In this example, the augmented reality process 200 includes a plurality of components including an AR device 210 that captures process data and provides the process data to an object recognition module 220. The object recognition module performs object recognition from the data and provides the object recognized data to a process learning module 230. The process learning module determines a state of a manual industrial process 250 (or operation) and provides data about the state to a scene construction module 240. The scene construction module 240 generates AR components for display by the AR device 210 based on a scene in which a user/operator is performing the process 250. Here, the scene construction module may overlay holographic components within a field of view of the user/operator wearing the AR device 210 and feedback the AR components to the AR device 210. FIG. 2 also illustrates that the manual industrial process 250 performed by the user/operator includes a plurality of steps.

In the example of FIG. 2, the process 200 is composed of four components including the AR device 210 which may include a group of sensors for data collection, the object recognition module 220 which may be a server/cloud service for computer vision/object recognition, the process learning module 230 which may include methods for encoding and modeling manual industrial process sequences, and the scene construction module 240 which may include a server/cloud service for packaging model outputs for presentation in the AR device 210. Each of the four modules may be used to create the overall learning system of the example embodiments. The system may learn process information based on object recognition 220. The system may also manage the process learning module 230 to continuously learn, and it may use the scene construction module 240 to convert the results of the process learning module 230 to create the holographic scene for the AR device 210.

The AR device 210 can collect data about manual industrial processes or operations performed by a user. As described herein, a manual industrial process can be defined as a series of state changes for a physical asset. There are many modes in which the states and/or changes to state can be recorded. Data can be collected from one or more front-facing cameras and depth sensors of an AR device. In other embodiments, the data can be dictated through onboard microphones on the AR device, or transmitted from sensors on the asset, or collected through the audio-visual inputs from multiple AR devices, or stationary environmental sensors such as motion capture sensors in the same environment. Other sensory data can also be used, such as accelerometer, thermocouple, magnetic field sensor, radio frequency emitters, etc. The sensors can be connected to the AR device 210 (via Bluetooth, Wi-Fi, etc.) or they can also be edge devices that report their states to databases directly. Ultimately, inputs from multiple devices may be combined to generate a cohesive context for the learning system.

In the object recognition module 220, one or more of machine readable labels, object classification, and optical character recognition may be performed on data within the captured images and audio to identify and track objects in the operator's field of view. The object recognition module 220 may combine the AR data stream from the AR device 210 with business specific data to accurately detect the type and timing of a process state change. The object recognition module 220 may encode the series of process state changes for consumption by the process learning module 230.

The process learning module 230 is comprised of a continuous learning method which can predict an expected state or future state, and state changes, of the currently observed process 250. The process learning module 230 may include a model training and execution environment that can consume encoded data from the object recognition module 220 and serve information to the scene construction module 240. A method of evaluating each new instance of a process is used to segregate training examples for desired outcomes and models for the desired outcomes are continuously updated with the new training examples. In this way, the process learning module 230 also has the capability of suggesting additional and more optimal paths for a given process by suggesting process steps that align with a desired outcome.

According to various embodiments, the AR device 210 can be configured to capture and annotate data received from one or more AR devices 210 (such as images, audio, spatial data, temperature, etc.) which may be used by the process learning module 230 to train one or more machine learning models on how to complete the manual industrial operation. The training can be continually performed as data continues to be received from the AR device 210. Accordingly, the learning can be adaptive and dynamic based on a current user manual industrial operation and previous manual industrial operations. Furthermore, the scene construction module 240 may output the one or more AR components (i.e., scene components) based on the trained machine learning models.

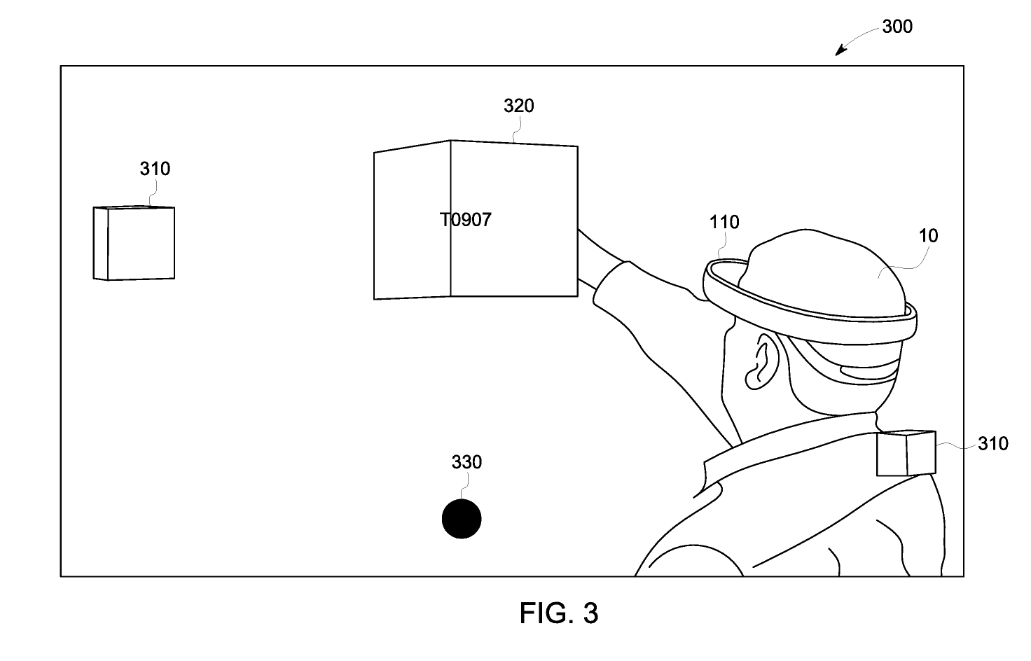

For example, the scene construction module 240 may combine the process predictions from the process learning module 230 with business specific logic to generate scene components for display by the AR device 210. Examples may include, but are not limited to, simple holographic indicators, text displays, audio/video clips, images, etc. Location and placement of virtual objects in the scene are tracked in this module and updated based on the results of the process learning module. Results from this module are then transmitted to the AR device for display to the user in real-time. A non-limiting example of the scene construction 300 with AR components is shown in FIG. 3. For example, one or more objects may be recognized and shown as being completed within the process, currently being worked on within the process, and expected to be worked on at some point in the future. In this example, labels 310 are used to indicate components of a manual industrial process that have been completed by user 10 wearing AR device 110, while label 320 indicates a component of a current state (e.g., a current step) of the manual industrial process operation. Also, indicator 330 provides an indication of a position of the next or future state of the manufacturing process within the scene. This is just merely an example, and different displays, indicators, paths, etc., may be used to guide the user or enhance the user's understanding of the process.

According to various embodiments, the AR learning system described herein can learn manufacturing processes without having them explicitly programmed. Also, the system can adapt to changes in the manufacturing process without reprogramming. The system can capture, store, and transmit detailed process knowledge. The system may perform continuous learning for manufacturing/assembly processes with operator performed actions. The system is designed to be a platform for AR devices that is extensible, and adaptable to a choice of hardware, model type, and process encoding strategy. The platform can also be configured to communicate with existing systems in place, such as product lifecycle management (PLM), computerized maintenance management system (CMMS), and the like. The models/platform are extensible to other types of industrial applications. Some examples include (but not limited to) assisting operators on a moving assembly line, assisting a sonographer in performing ultrasound of an organ, assisting the proper opening and closing of valves in a power plant restart, and the like. The system is further capable of providing efficient instructions to the operator (novice and experts) thereby increasing throughput, efficiency and compliance while minimizing errors and costs.

The example embodiments were tested/demonstrated for a pick and place assembly process in an electrical cabinet. The AR device used was a Microsoft HoloLens and the AR platform was a Python/Flask server. In addition, OpenCV and Theano were used for the object recognition and process learning module, respectively. The scene construction module is a custom-built REST service built using Swagger. Electrical components in the pick and place assembly process were labeled with QR codes manually. An image feed from the HoloLens device was passed to the REST API where QR code recognition in OpenCV was used as a simplified example of object recognition. A custom service was created to operate with OpenCV and encode the assembly process using a string encoding method similar to Simplified Molecular-Input Line-Entry System (SMILES). This method represents the pick and place process as an information graph with nodes equal to a unique component identifier. The change of state is an addition or a deletion of a component identifier; a state is defined as the complete string at any given time.

The process was modeled using a recurrent neural network (RNN) that consumes the string encoded graph of the assembly process. The RNN was trained on a set of simulated data for the pick and place task and can predict the subsequent component given the current state. For example, if the RNN were trained on data and given a current state (component A), it would predict an equal likelihood that the next component to be operated on by the user in the operation is component B or component C. The system is trained to not only predict a process sequence of a manual industrial operation, but also suggest paths that are better quality, or more efficient. In the simulated data, some paths are more efficient and a RNN is trained to provide such paths. Similarly, other paths lead to higher quality and a separate RNN may be trained to provide high quality paths. Thus, the process learning module 230 can suggest paths that are more likely to proceed efficiently and/or with highest quality.

Other embodiments might use different models, or model ensembles, for predicting subsequent states including auto-regression model, Hidden Markov Model, Conditional Random Field, Markov network, Bayesian network. Both Markov network and Bayesian network infer from general graph structure and can be used where a graph structure exists between process steps; however, this would require changing encoding methodology, as the current encoding embodiment assumes a chain structure. Hidden Markov Model and Conditional Random Field can be used with the current encoding with additional constraints on the models; these models can allow for more complex inference than the current RNN model. On the other hand, the auto-regression model can be considered for simplification, as it assumes linear dependencies, unlike the general nonlinear RNN model.

In the scene construction module 240, the placement of parts in an electrical cabinet assembly is evaluated against a part layout using holographic indicators. Simple holograms may be provided to indicate when a part is present, but not detected, detected but not properly placed, or detected and properly placed. These holograms and their placement may be packaged for and rendered on the AR device 210 (e.g., HoloLens) in real-time.

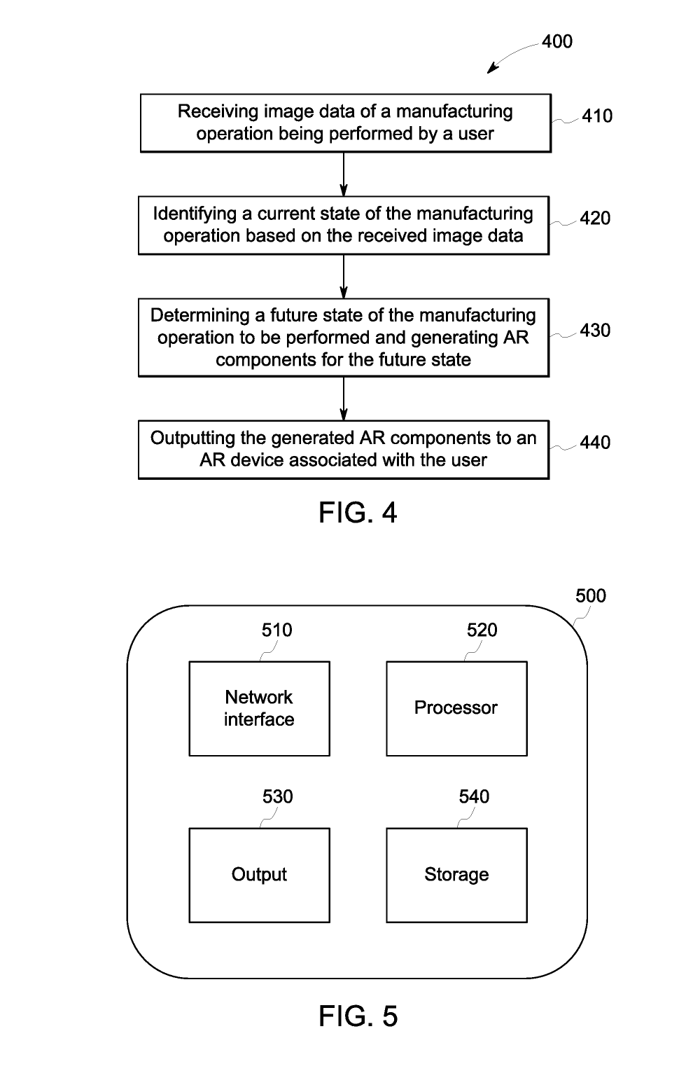

FIG. 4 illustrates a method 400 for generating an augmented reality in accordance with an example embodiment. For example, the method 400 may be controlled by AR software executing on an AR device, an AR server, a cloud computing system, a user computing device, or a combination thereof. The software may control the hardware of the device to perform the method 400. Referring to FIG. 4, in 410, the method includes receiving data that is captured of a manual industrial operation being performed by a user. The manual industrial operations may be manufacturing of a component, repair, assembly, inspection, cleaning maintenance, and the like, performed by the user. The received data may include images, pictures, video, spatial data (spatial map), temperature, thermal data, and the like, captured of a user performing or about to perform the manual industrial operation. In some embodiments, the received data may also or instead include audio data such as spoken commands, instructions, dialogue, explanations, and/or the like. The image data may include a picture of a scene and/or a surrounding location at which the manual industrial operation is being performed, a picture of a machine or equipment, a picture of the user interacting with the machine or equipment or preparing to interact with the machine or equipment, and the like. The image data may be captured by an AR device such as a pair of glasses, a helmet, a band, a camera, and the like, which may be worn by or attached to the user.

In 420, the method includes identifying a current state of the manual industrial operation that is being performed by the user based on the received image data. For example, the manual industrial operation may include a plurality of steps which are to be performed by the user including an initial step, a finishing step, and one or more intermediate steps. The AR software may identity a current step being performed by the user as the current state of the manual industrial operation. For example, the AR device executing the AR software may store a process map or model that includes reference pictures, images, description, sounds, etc., about each step of the manual industrial operation which are received from historical performances and/or the current performance of the manual industrial operation. The AR software may determine that the current step is the initial step, an intermediate step, the final step, and the like.

In 430, the method further includes determining a future state of the manual industrial operation that will be performed by the user based on the current state, and generating one or more augmented reality (AR) components based on the future state of the manual industrial operation. Here, the future state of the manual industrial operation may be performed by a learning system of the AR software. Although not shown in FIG. 4, the method may further include performing object recognition on the received image data to identify and track objects in the user's field of view, and generating encoded data of the manual industrial operation being performed representing one or more state changes of the manual industrial operation based on the object recognition. Furthermore, the encoded data may be input to the learning system that continuously receives and learns from the encoded data of the operation being performed, predicts state changes that will occur for the operation based on the learning, and determines the future state of the operation based on the predicted state changes.

Furthermore, in 440 the method includes outputting the one or more AR components to an AR device of the user for display based on a scene of the manual industrial operation. In some embodiments, the AR components may be output for display by the same AR device that captured the initial data of the operation being performed. For example, the image data may be captured by a pair of lenses and/or a helmet worn by the user, and the AR components may also be output to the pair of lenses and/or the helmet. In some embodiments, additional image data of the manual industrial operation being performed by the user is simultaneously received from the AR device being worn by the user while the one or more AR components are being output to the AR device being worn by the user. For example, the AR device may capture image data of a next step of the manual industrial operation being performed while the AR software outputs AR components of the next step of the manual industrial operation being performed.

In some embodiments, the output AR components output in 440 may indicate a suggested path for performing the manual industrial operation within a field of view of the user. In some cases, holographic indicators may be output that include at least one of images, text, video, 3D objects, CAD objects, arrows, pointers, symbols, and the like, within the scene which can aid the user. Also, the AR software may update the AR components being output for display in the scene based on a progress of the manual industrial operation being performed by the user. For example, when the AR software detects that the user is performing the next step of the operation, the AR software may output AR components related to the step that is in the future with respect to the next step.

FIG. 5 illustrates a computing system 500 for generating an augmented reality in accordance with an example embodiment. For example, the computing system 500 may be a cloud platform, a server, a user device, or some other computing device with a processor. Also, the computing system 500 may perform the method of FIG. 4. Referring to FIG. 5, the computing system 500 includes a network interface 510, a processor 520, an output 530, and a storage device 540. Although not shown in FIG. 5, the computing system 500 may include other components such as a display, an input unit, a receiver/transmitter, and the like. The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the device 500, an externally connected display, an AR device, a cloud instance, another device or software, and the like. The storage device 540 is not limited to any particular storage device and may include any known memory device such as RAM, ROM, hard disk, and the like.

According to various embodiments, the storage 540 may store image data captured of a manual industrial operation being performed by a user. Here, the image data may be captured by an AR device being worn by the user, attached to the user, or associated with the manual industrial operation. The processor 520 may identify a current state of the manual industrial operation that is being performed by the user based on the received image data, determine a future state of the manual industrial operation that will be performed by the user based on the current state, and generate one or more augmented reality (AR) components based on the future state of the manual industrial operation. Furthermore, the output 530 may output the one or more AR components to an AR device of the user for display based on a scene of the manual industrial operation. In some embodiments, the same AR device that initially captured the image data may also output the AR components for display. Here, the computing system 500 may be embedded within the AR device, or it may be connected to the AR device via a cable or via a network connection. For example, the network interface 510 may receive image data and other information from the AR device via a network such as the Internet. In this case, the image data of the operation being performed may be received simultaneously with AR components associated with the operation being displayed.

In some embodiments, the processor 520 may perform object recognition on the received image data to identify and track objects in the user's field of view, and generate encoded data of the manual industrial operation being performed representing one or more state changes of the manual industrial operation based on the object recognition. In this case, the processor 520 may generate or manage a manual industrial process learning system that continuously receives and learns from the encoded data of the manual industrial operation being performed, predicts state changes that will occur for the manual industrial operation based on the learning, and determines the future state of the manual industrial operation based on the predicted state changes.

In some embodiments, the output 530 may output the one or more AR components, via the AR device, to indicate a suggested path for the manual industrial operation within a field of view of the user. For example, the one or more AR components that are output may include holographic indicators including at least one of images, text, video, 3D objects, CAD models, arrows, pointers, symbols, and the like, within the scene. In some embodiments, the processor 520 may control the output 530 to update the one or more AR components being output for display in the scene based on a progress of the manual industrial operation being performed by the user.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

1. A computer-implemented method comprising:
receiving data that is captured of a manual industrial operation being performed by a user;
identifying a current state of the manual industrial operation that is being performed by the user based on the received data;
determining a future state of the manual industrial operation that will be performed by the user based on the current state, and generating one or more augmented reality (AR) components based on the future state of the manual industrial operation; and
outputting the one or more AR components to an AR device of the user for display based on a scene of the manual industrial operation;
wherein the data is received from at least one AR device being worn by the user, and the one or more AR components are also output to the at least one AR device being worn by the user.

2. (canceled)

3. The computer-implemented method of claim 1,
wherein additional data of the manual industrial operation being performed is simultaneously received from the at least one AR device being worn by the user while the one or more AR components are being output to the at least one AR device being worn by the user.

4. The computer-implemented method of claim 1, wherein the received data of the manual industrial operation comprises at least one of images, sound, spatial data, and temperature, captured of the manual industrial operation being performed by the user.

5. The computer-implemented method of claim 1, wherein the received data comprises received image data, and the method further comprises:
performing object recognition on the received image data to identify and track objects in the user's field of view, and
generating encoded data of the manual industrial operation being performed representing one or more state changes of the manual industrial operation based on the object recognition.

6. The computer-implemented method of claim 4, further comprising generating a manual industrial process learning system that continuously receives and learns from the encoded data of the manual industrial operation being performed, predicts state changes that will occur for the manual industrial operation based on the learning, and determines the future state of the manual industrial operation based on the predicted state changes.

7. The computer-implemented method of claim 1, wherein the outputting comprises outputting the one or more AR components, via the AR device, to indicate a suggested path for the manual industrial operation within a field of view of the user.

8. The computer-implemented method of claim 1, wherein the outputting the one or more AR components comprises outputting holographic indicators including at least one of images, text, video, audio, and three-dimensional (3D) objects, within the scene.

9. The computer-implemented method of claim 1, wherein the outputting comprises updating the one or more AR components being output for display in the scene based on a progress of the manual industrial operation being performed by the user.

10. The computer-implemented method of claim 1, wherein the AR device is configured to capture and annotate data to train one or more machine learning models on how to complete the manual industrial operation, and the generating and the outputting of the one or more AR components are performed based on the trained machine learning models.

11. A computing system comprising:
a storage device configured to store data captured of a manual industrial operation being performed by a user;
a processor configured to identify a current state of the manual industrial operation that is being performed by the user based on the received data, determine a future state of the manual industrial operation that will be performed by the user based on the current state, and generate one or more augmented reality (AR) components based on the future state of the manual industrial operation; and
an output configured to output the one or more AR components to an AR device of the user for display based on a scene of the manual industrial operation;
wherein the data is received from at least one AR device being worn by the user, and the one or more AR components are also output to the at least one AR device being worn by the user.

12. (canceled)

13. The computing system of claim 11, wherein additional data of the manual industrial operating being performed is simultaneously received from the at least one AR device being worn by the user while the one or more AR components are being output to the at least one AR device being worn by the user.

14. The computing system of claim 11, wherein the received data comprises at least one of images, sound, a spatial map, and temperature, captured of the manual industrial operation being performed by the user.

15. The computing system of claim 11, wherein the received data comprises image data, and the processor is further configured to perform object recognition on the received image data to identify and track objects in the user's field of view, and generate encoded data of the manual industrial operation being performed representing one or more state changes of the manual industrial operation based on the object recognition.

16. The computing system of claim 15, wherein the processor is further configured to generate a manual industrial process learning system that continuously receives and learns from the encoded data of the manual industrial operation being performed, predicts state changes that will occur for the manual industrial operation based on the learning, and determines the future state of the manual industrial operation based on the predicted state changes.

17. The computing system of claim 11, wherein the output is configured to output the one or more AR components, via the AR device, to indicate a suggested path for the manual industrial operation within a field of view of the user.

18. The computing system of claim 11, wherein the processor controls the output to update the one or more AR components being output for display in the scene based on a progress of the manual industrial operation being performed by the user.

19. A non-transitory computer readable medium having stored therein instructions that when executed cause a computer to perform a method comprising:
receiving data that is captured of a manual industrial operation being performed by a user;
identifying a current state of the manual industrial operation that is being performed by the user based on the received data;
determining a future state of the manual industrial operation that will be performed by the user based on the current state, and generating one or more augmented reality (AR) components based on the future state of the manual industrial operation; and
outputting the one or more AR components to an AR device of the user for display based on a scene of the manual industrial operation;
wherein the data is received from at least one AR device being worn by the user and the one or more AR components are also output to the at least one AR device being worn by the user.

20. (canceled)

21. The computer-implemented method of claim 1, wherein identifying the current state of the manual industrial operation that is being performed includes identifying the current state among a plurality of different processes stored in an AR server.

22. The computer-implemented method of claim 5, wherein performing object recognition on the received image data includes one or more of performing machine readable labels, object classification, and optical character recognition on the received image data.

23. The computer-implemented method of claim 5, wherein performing object recognition on the received image data includes combining the received image data with business specific data to accurately detect a type and timing of a process state change in the manual industrial operation.

24. The computer-implemented method of claim 23, wherein the manual industrial operation is represented as an information graph and wherein each node of the information graph represents a unique component identifier.

25. The computer-implemented method of claim 24, wherein the process state change is represented by an addition or a deletion of a component identifier.

26. The computer-implemented method of claim 10, wherein the machine learning model comprises at least one of a recurrent neural network (RNN) model, an auto-regression model, a Hidden Markov Model, a Conditional Random Field model, a Markov network model, or a Bayesian network model.
